(19) United States
(12) Patent Application Publication
(10) Pub. No.: US 2020/0404187 A1
(43) Pub. Date: Dec. 24, 2020

(54) IN-VEHICLE INFORMATION RECORDING DEVICE

(71) Applicant: TOYOTA JIDOSHA KABUSHIKI KAISHA, Toyota-shi (JP)

(72) Inventor: Tomoaki IIDA, Okazaki-shi (JP)

(73) Assignee: TOYOTA JIDOSHA KABUSHIKI KAISHA, Toyota-shi (JP)

(21) Appl. No.: 16/850,717

(22) Filed: Apr. 16, 2020

(30) Foreign Application Priority Data
Jun. 24, 2019 (JP) 2019-116382

(51) Int. Cl. H04N 5/247; H04N 7/18; H04N 5/77

(52) U.S. Cl. CPC H04N 5/247; H04N 5/77; H04N 7/18

(57) ABSTRACT

An information recording device includes a first capturing unit, a second capturing unit, an information acquisition unit, and a recording unit. The first capturing unit captures a first image at a first angle of view. The first image includes at least a part of a target vehicle in front of or behind a vehicle and the surrounding area of the target vehicle. The second capturing unit captures a second image at a second angle of view that is narrower than the first angle of view. The second image includes target information so that the target information on a specific target part of the target vehicle or the surrounding area is identifiable. The information acquisition unit acquires the target information from the second image. The recording unit records the target information, acquired by the information acquisition unit, in association with the first image.

### INCORPORATION BY REFERENCE

The disclosure of Japanese Patent Application No. 2019-116382 filed on Jun. 24, 2019 including the specification, drawings and abstract is incorporated herein by reference in its entirety.

### BACKGROUND

### 1. Technical Field

The present disclosure relates to an in-vehicle information recording device.

### 2. Description of Related Art

Japanese Unexamined Patent Application Publication No. 2013-80518 (JP 2013-80518 A) discloses an in-vehicle moving image data recording device that compresses a camera-unit captured image at high quality and records the high-quality moving image data based on a trigger detection time at which an abnormal situation is detected by a trigger detection unit.

### SUMMARY

There is a vehicle equipped with a plurality of cameras (capturing units) having different angles of view in order to perform driving assistance. The angle of view of a camera used for driving assistance is generally narrower or wider than the angle of view of a camera suitable for vehicle information recording. Therefore, when mounting an information recording device (drive recorder) for recording information about vehicles such as that disclosed in JP 2013-80518 A, it is necessary to mount a camera dedicated for the information recording device and, therefore, there is room for improvement.

The present disclosure provides an in-vehicle information recording device that can record an image suitable for vehicle information recording without adding a new capturing unit.

A first aspect of the present disclosure relates to an in-vehicle information recording device including a first capturing unit, a second capturing unit, an information acquisition unit, and a recording unit. The first capturing unit is configured to capture a first image at a first angle of view. The first image includes at least a part of a target vehicle in front of or behind a vehicle and the surrounding area of the target vehicle. The second capturing unit is configured to capture a second image at a second angle of view that is narrower than the first angle of view. The second image includes target information so that the target information on a specific target part of the target vehicle or the surrounding area is identifiable. The information acquisition unit is configured to acquire the target information from the second image. The recording unit is configured to record the target information in association with the first image. The target information is acquired by the information acquisition unit.

In the in-vehicle information recording device according to the first aspect of the present disclosure, the first capturing unit captures the first image at the first angle of view. The second capturing unit captures the second image, which includes the target information, at the second angle of view that is narrower than the first angle of view so that the target information on the specific target part of the target vehicle or the surrounding area can be identified. In addition, the information acquisition unit acquires the target information from the second image. Then, the recording unit records the target information in association with the first image. Thus, even when not identified in the first image, the specific target part can be identified by the target information associated with the first image. This allows an image suitable for the information recording of the vehicle to be recorded without adding a new capturing unit.

In the in-vehicle information recording device according the first aspect, the recording unit may be configured to record the target information in association with the first image. The target information includes number information on the target vehicle.

In the in-vehicle information recording device according to the first aspect, since the target information includes the number information, one target vehicle can be uniquely identified based on the target information. This allows the target vehicle to be identified without recording a plurality pieces of target information.

In the in-vehicle information recording device according to the first aspect, the recording unit may be configured to record the target information in association with the first image. The target information includes vehicle traveling rule information on the surrounding area.

In the in-vehicle information recording device according to the first aspect, the target information includes the vehicle traveling rule information on the surrounding area. Therefore, it is possible to determine whether the target vehicle, which has been recorded, is traveling in compliance with the vehicle traveling rule.

In the in-vehicle information recording device according to the first aspect, the horizontal angle of view that is the first angle of view of the first capturing unit may be set to 180° or more.

In the in-vehicle information recording device according to the first aspect, since the horizontal angle of view of the first capturing unit is set to 180° or more, the capturing range is larger than that of a configuration in which the horizontal angle of view is less than 180°. This means that more surrounding information on the vehicle can be acquired.

As described above, the present disclosure provides an excellent effect that an image suitable for vehicle information recording can be recorded without adding a new capturing unit.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a plan view showing an arrangement and the angle of view of each camera in a vehicle to which an information recording device according to the embodiment is applied;

FIG. 2 is an image diagram showing an example of a field of view visually recognized by an occupant through the front windshield glass of the vehicle to which the information recording device according to the embodiment is applied;

FIG. 3 is a block diagram showing a hardware configuration of the information recording device according to the embodiment;

FIG. 4 is a block diagram showing a functional configuration of the information recording device according to the embodiment;

FIG. 5 is a diagram showing a relationship between an inter-vehicle distance and whether the number information can be identified in an image captured by the vehicle to which the information recording device according to the embodiment is applied;

FIG. 6 is an image diagram showing a state in which the number information on the following vehicle cannot be identified in a second image captured by the rear narrow-angle camera shown in FIG. 3;

FIG. 7 is an image diagram showing a state in which it is difficult to identify the number information on the following vehicle in a second image captured by the rear narrow-angle camera shown in FIG. 3;

FIG. 8 is an image diagram showing a state in which the number information on the following vehicle is identified in a second image captured by the rear narrow-angle camera shown in FIG. 3;

FIG. 9 is an image diagram showing a recorded image in which the number information on the following vehicle is combined with a first image captured by the rear wide-angle camera shown in FIG. 3;

FIG. 10 is a flowchart showing the flow of processing in which the number information on the following vehicle is combined with a first image in the information recording device according to the embodiment;

FIG. 11A is an image diagram showing a second image captured by the front narrow-angle camera shown in FIG. 1;

FIG. 11B is an image diagram showing a recorded image in which the number information on the preceding vehicle and the regulated speed information are combined with a first image captured by the front wide-angle camera shown in FIG. 1; and

FIG. 12 is an image diagram showing a recorded image in which the number information on three following vehicles is associated with a first image captured by an information recording device according to a modification of the embodiment.

### DETAILED DESCRIPTION OF EMBODIMENTS

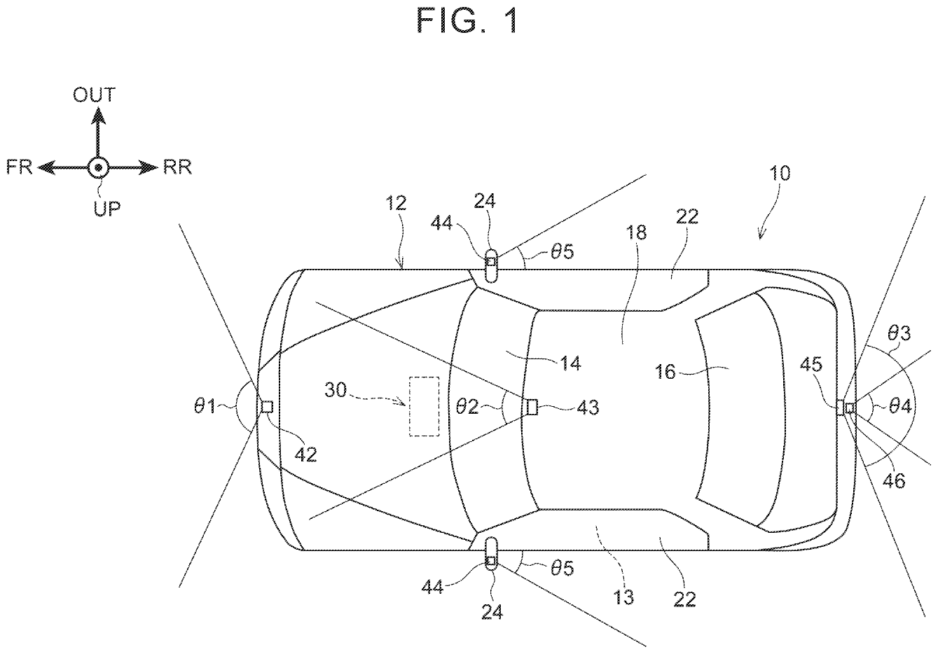

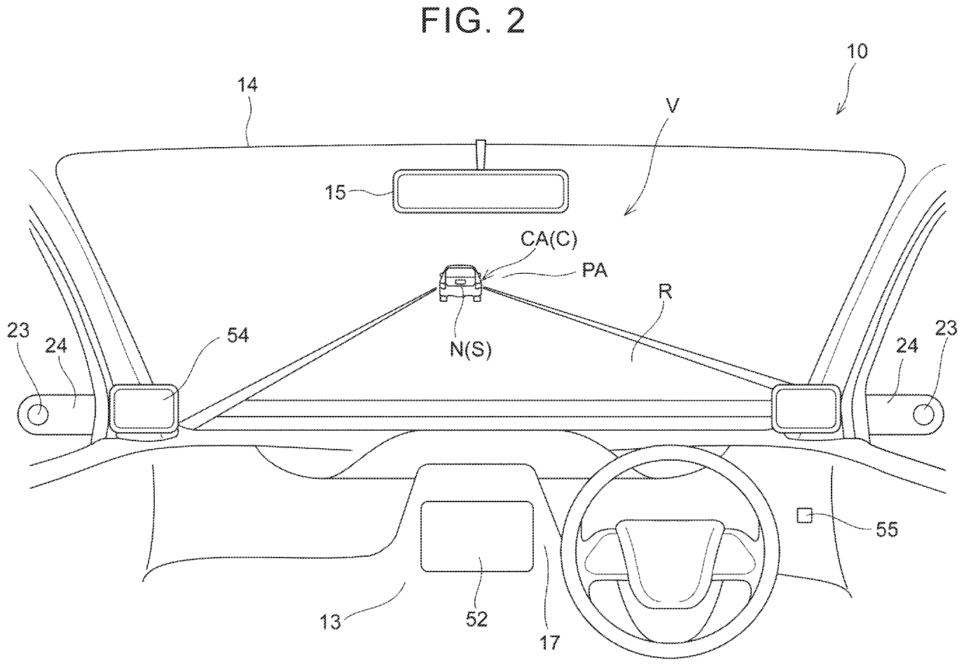

FIG. 1 is a plan view of a vehicle 10 to which an information recording device 30 is applied. The information recording device 30 is an example of an in-vehicle information recording device according to this embodiment. The vehicle 10 includes a vehicle body 12, a front windshield glass 14, a rear windshield glass 16, and the information recording device 30. The vehicle body 12 includes a roof 18, a pair of right-side and left-side doors 22, and camera supports 24 provided one on each side door 22. Each of the camera support 24 supports an electronic mirror camera 23 (see FIG. 2).

The arrow FR indicates the forward longitudinal direction of the vehicle, the arrow RR indicates the rearward longitudinal direction of the vehicle, the arrow UP indicates the upward vertical direction of the vehicle, and the arrow OUT indicates the outward width direction of the vehicle. The vehicle longitudinal direction, the vehicle vertical direction, and the vehicle width direction are directions orthogonal to each other. In the description below, when the direction is mentioned simply using front-rear, up-down, or right-left, it is assumed that front-rear in the vehicle longitudinal direction, up-down in the vehicle vertical direction, or right-left in the vehicle width direction with respect to the traveling direction is mentioned.

FIG. 2 shows the field of view V in front of the vehicle viewed from the vehicle cabin 13 of the vehicle 10. For example, a preceding vehicle CA is traveling in front of the vehicle 10 on the traveling route (roadway) R. In the vehicle cabin 13, a main monitor 52, which will be described later, is provided on an instrument panel 17. In addition, a pair of left and right sub-monitors 54 is provided in the vehicle cabin 13. The vehicle 10 is provided with a global positioning system (GPS) receiver, a communication interface (IF), and a collision detection sensor, all of which are not shown.

Next, the information recording device 30 will be described.

### Hardware Configuration

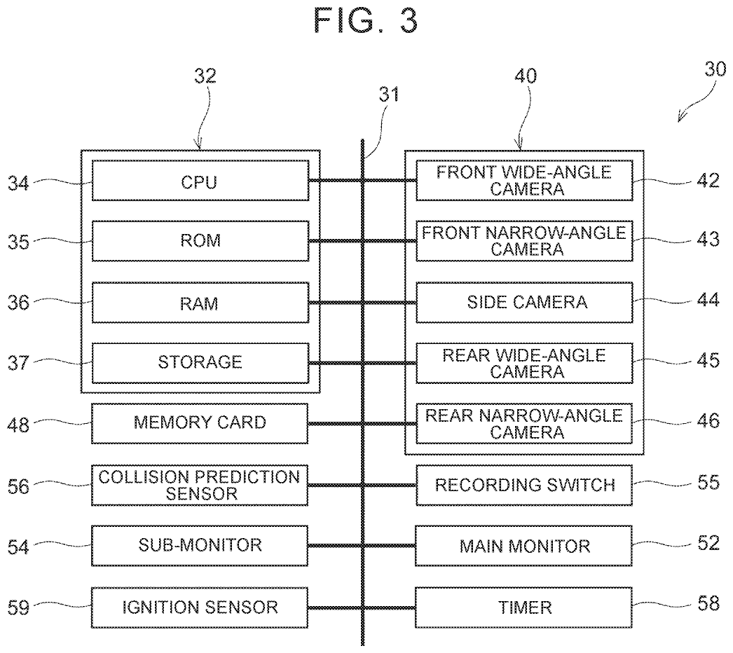

As shown in FIG. 3, the information recording device 30 includes, for example, an ECU 32, a camera unit 40, a memory card 48, the main monitor 52, the sub-monitors 54, a recording switch 55, a collision prediction sensor 56, a timer 58, and an ignition sensor 59. ECU means an electronic control unit. These components are communicably connected to each other via an internal bus 31.

The ECU 32 has a central processing unit (CPU) 34, a read only memory (ROM) 35, a random access memory (RAM) 36, and a storage 37.

The ROM 35 stores various programs and various data. The RAM 36, used as a work area, temporarily stores a program or data. The storage 37, configured for example by a flash read only memory (ROM), stores various programs including the operating system and various data. The CPU 34 executes various programs, such as the information recording processing programs recorded in the ROM 35 or the storage 37, to control the operation of each part of the information recording device 30 and the recording of various information.

The camera unit 40 includes, for example, a front wide-angle camera 42, a front narrow-angle camera 43, side cameras 44, a rear wide-angle camera 45, and a rear narrow-angle camera 46. A camera having a relatively large angle of view (viewing angle) is referred to as a “wide-angle camera”, and a camera having a smaller (narrower) angle of view than the angle of view of a “wide-angle camera” is referred to as a “narrow-angle camera”. In the description below, the “angle of view” means the “horizontal angle of view”, but is not limited thereto; the “angle of view” may be set as the “vertical angle of view” or the “diagonal angle of view”. The angle of view may be converted into an angle of view based on the aspect ratio of an image (video) that is set in advance.

Each camera of the camera unit 40 includes a lens and an image sensor such as a charge-coupled device (CCD) and a complementary metal oxide semiconductor (CMOS). Furthermore, the capturing frequency of an image (video) by each camera is set, for example, to about 30 ms (millisecond).

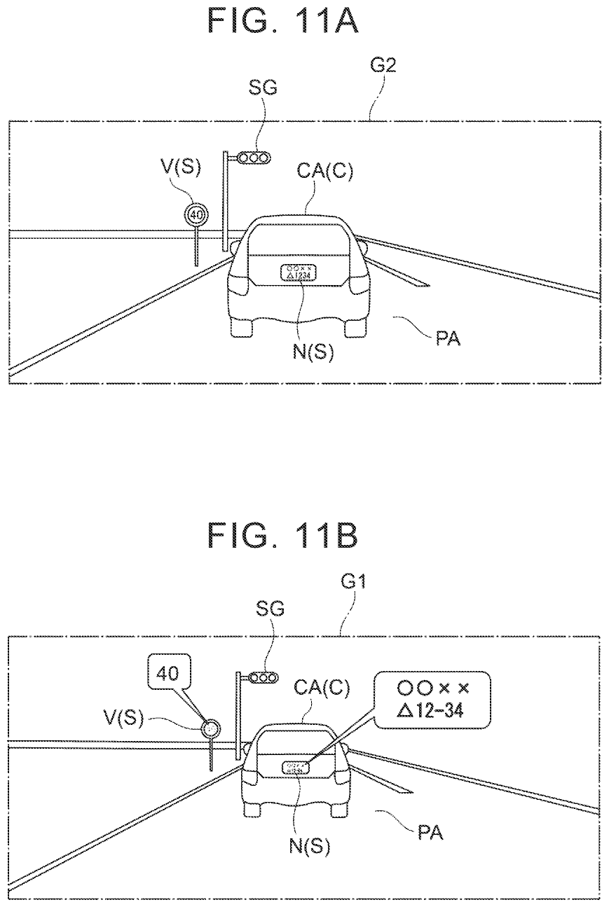

As shown in FIG. 1, the front wide-angle camera 42 is mounted, for example, at the front end of the vehicle body 12 and at the center in the vehicle width direction to capture a first image G1 in front of the vehicle 10 (see FIG. 11B) at a first angle of view θ1. The first angle of view θ1 is set, for example, to 180° or more (in this example,) 200°. In FIG. 1, for illustration purposes, the first angle of view θ1 and the first angle of view θ3, which will be described later, are shown at an angle smaller than 200°. The information on the first image G1 captured by the front wide-angle camera 42 is output to the ECU 32 (see FIG. 3). An example of the front wide-angle camera 42 is a panoramic view monitor camera.

For example, the front narrow-angle camera 43 is provided near the stay of the room mirror 15 (see FIG. 2) in the vehicle cabin 13 to capture a second image G2 in front of the vehicle 10 (see FIG. 11A) at a second angle of view θ2. The second angle of view θ2 is smaller than the first angle of view θ1. The information on the second image G2, captured by the front narrow-angle camera 43, is output to the ECU 32. The second image G2 is used to identify (analyze) the information on the license plate N (see FIG. 2) of the preceding vehicle CA. An example of the front narrow-angle camera 43 is a camera used as a situation detection unit that detects the situation in the area in front of the vehicle (a camera for recognizing road signs, for recognizing the preceding vehicle, and for recognizing white lines ahead).

The side cameras 44 are provided below a pair of right and left camera supports 24 (under the electronic mirror cameras 23 (see FIG. 2)). The side cameras 44 capture the images behind, and to the sides of, the vehicle 10. The image information captured by the side cameras 44 is sent to the ECU 32. The angle of view of the side cameras 44 is θ5.

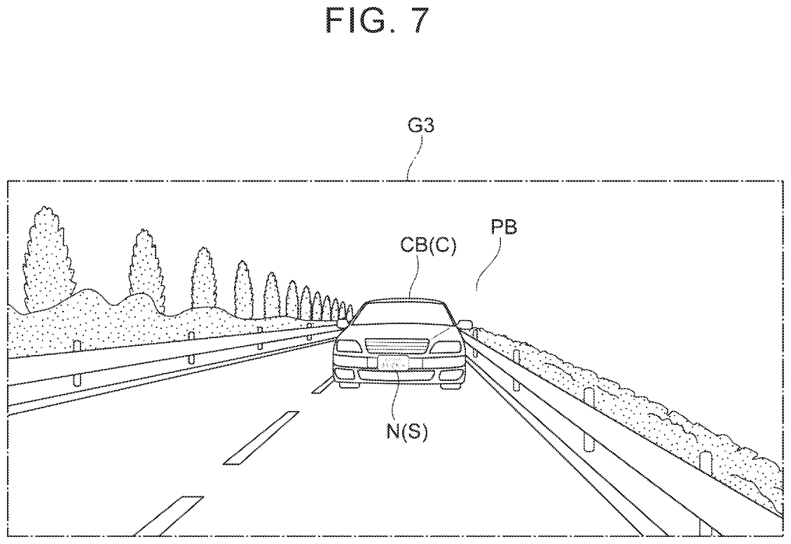

The rear wide-angle camera 45, mounted for example at the rear end of the vehicle body 12 and at the center in the vehicle width direction, captures a first image G3 (see FIG. 7) behind the vehicle 10 at a first angle of view θ3. The first angle of view θ3 is set, for example, to 180° or more (in this example, 200°). The information on the first image G3, captured by the rear wide-angle camera 45, is output to the ECU 32. An example of the rear wide-angle camera 45 is a camera for a back-guide monitor.

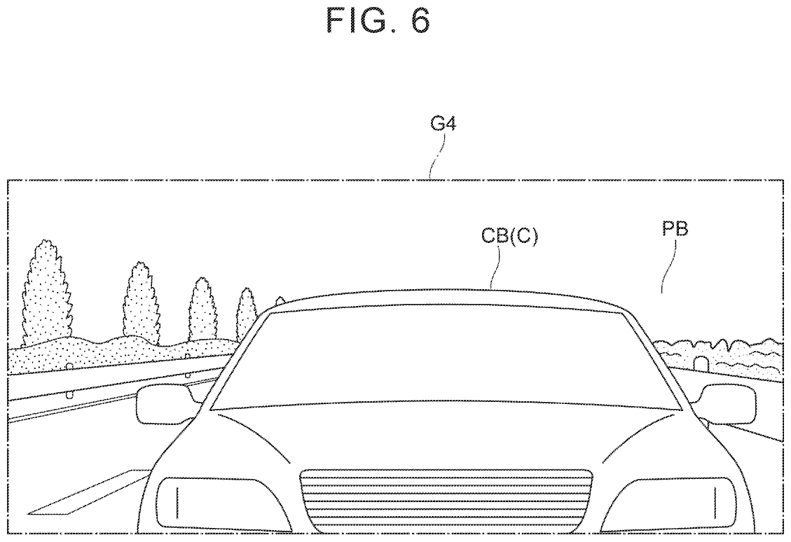

The rear narrow-angle camera 46, mounted for example at the rear end of the vehicle body 12 and at the center in the vehicle width direction below the rear wide-angle camera 45, captures a second image G4 (see FIG. 6) behind the vehicle 10 at a second angle of view θ4. The second angle of view θ4 is narrower than the first angle of view θ3. The information on the second image G4, captured by the rear narrow-angle camera 46, is output to the ECU 32. The second image G4 is used to identify (analyze) the information on the license plate N (see FIG. 7) of the following vehicle CB. An example of the rear narrow-angle camera 46 is a camera for an electronic inner mirror.

The memory card 48 shown in FIG. 3 is inserted into the slot of a card reader (not shown), provided in the information recording device 30, to acquire the information and to record the acquired information therein.

The main monitor 52 shown in FIG. 2 includes a touch panel (not shown). The main monitor 52 can display each image captured by the camera unit 40 (see FIG. 3). The sub-monitors 54 display an image captured by the electronic mirror cameras 23.

The recording switch 55, provided on the instrument panel 17, is turned on and off by an occupant (driver) not shown. The signal of the recording switch 55 is output to the ECU 32 (see FIG. 3). When the recording switch 55 is turned on, the combined information, which will be described later, is recorded on the memory card 48 (see FIG. 3). When the recording switch 55 is turned off, the recording of the combined information to the memory card 48 is stopped.

The collision prediction sensor 56 shown in FIG. 3 includes a millimeter wave radar, a laser radar, an in-vehicle camera, and the like (not shown). In the vehicle 10, the information on collision prediction is output from the collision prediction sensor 56 to the ECU 32. In this embodiment, the output signal from the recording switch 55 and the output signal from the collision prediction sensor 56 are used as a trigger signal for starting the recording of the combined information which will be described later. For example, the collision prediction sensor 56 can be used for measuring the inter-vehicle distance between the vehicle 10 and a target vehicle C which will be described later.

The timer 58 sends the current time (time) information to the ECU 32. In response to an instruction from the ECU 32, the timer 58 is configured to be able to measure the time between two time points. The time information measured by the timer 58 is sent to the ECU 32.

The ignition sensor 59 detects the ON state (start state) or the OFF state (stop state) of the ignition key (not shown) of the vehicle 10. The information on the ON state or the OFF state detected by the ignition sensor 59 is sent to the ECU 32.

### Functional Configuration

The information recording device 30 implements various functions using the above hardware resources when executing the information recording processing programs. The functional configuration implemented by the information recording device 30 will be described below. For the description of each component shown in FIG. 1, FIG. 2, and FIG. 3, the figure number may be omitted.

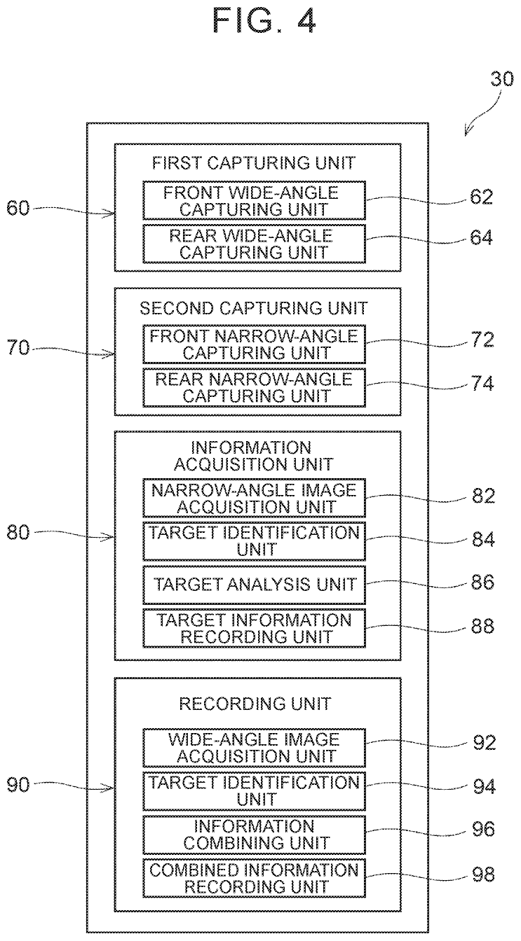

As shown in FIG. 4, the information recording device 30 includes a first capturing unit 60, a second capturing unit 70, an information acquisition unit 80, and a recording unit 90 as the functional components. The CPU 34 of the information recording device 30 reads a program and information from the ROM 35 or the storage 37 into the RAM 36 to implement each functional component.

### First Capturing Unit

The first capturing unit 60 includes a front wide-angle capturing unit 62 and a rear wide-angle capturing unit 64.

The front wide-angle capturing unit 62 captures the first image G1 (see FIG. 11B) at the first angle of view θ1. The first image G1 includes at least a part of the target vehicle C ahead of the vehicle 10 (hereinafter, referred to as “preceding vehicle CA”) and the surrounding area PA of the preceding vehicle CA. The image information on the first image G1 is sent to the recording unit 90. The rear wide-angle capturing unit 64 captures the first image G3 (see FIG. 7) at the first angle of view θ3. The first image G3 includes at a part of the target vehicle C behind the vehicle 10 (hereinafter, referred to as following vehicle CB) and the surrounding area PB of the following vehicle CB. The image information on the first image G3 is sent to the recording unit 90.

### Second Capturing Unit

The second capturing unit 70 includes a front narrow-angle capturing unit 72 and a rear narrow-angle capturing unit 74.

The front narrow-angle capturing unit 72 captures the second image G2, which includes the target information, at the second angle of view θ2, which is narrower than the first angle of view θ1, so that the target information on a specific target part S (see FIG. 2) of the preceding vehicle CA and the surrounding area PA can be identified. The image information on the second image G2 is sent to the recording unit 90. The rear narrow-angle capturing unit 74 captures the second image G4, which includes the target information, at the second angle of view θ4, which is narrower than the first angle of view θ3, so that the target information on the specific target part S of the following vehicle CB and the surrounding area PB can be identified. The image information on the second image G4 is sent to the recording unit 90.

The specific target part S means a target part that is included in at least one of the target vehicle C and the surrounding area P. This target part is a part including the information that needs to be identified and recorded. In the description below, the license plate N of the target vehicle C and the speed sign V (see FIG. 11A) are used as an example of the specific target part S. In addition, for the specific target part S, the number information on the license plate N and the regulated speed information on the speed sign V are set as an example of the target information that needs to be recorded in the recording unit 90 that will be described later.

### Information Acquisition Unit

The information acquisition unit 80 acquires the target information (number information and regulated speed information) on the specific target part S from the second image G2 and the second image G4. More specifically, the information acquisition unit 80 includes, for example, a narrow-angle image acquisition unit 82, a target identification unit 84, a target analysis unit 86, and a target information recording unit 88.

The he narrow-angle image acquisition unit 82 acquires the information on the second image G2 and the second image G4 from the second capturing unit 70. The target identification unit 84 uses, for example, a known pattern matching technique and a known area recognition technique to identify (detect) the license plate N and the speed sign V included in the second image G2 and the second image G4. The target analysis unit 86 uses, for example, a known optical character recognition (OCR) method for the license plate N and the speed sign V, identified by the target identification unit 84, to analyze the number information and regulated speed information and converts the analyzed result into text.

The target information recording unit 88 temporarily stores the number information and the regulated speed information that have been converted into text by the target analysis unit 86. In other words, the number information and the regulated speed information, stored in the target information recording unit 88, are automatically deleted or overwritten when a preset setting time has elapsed. The number information and the regulated speed information are sent to the recording unit 90. Note that, when the trigger signal which will be described later is received by the ECU 32, the number information and the regulated speed information recorded during the time before and after the reception of the trigger signal are saved.

### Recording Unit

The recording unit 90 records the target information (number information and regulated speed information), acquired by the information acquisition unit 80, in association with the first image G1 and the first image G3. More specifically, the recording unit 90 includes a wide-angle image acquisition unit 92, a target identification unit 94, an information combining unit 96, and a combined information recording unit 98.

The wide-angle image acquisition unit 92 acquires the first image G1 and the first image G3 from the first capturing unit 60. The target identification unit 94 identifies the license plate N and the speed sign V included in the first image G1 and the first image G3 acquired by the wide-angle image acquisition unit 92. Note that the identification of a target by the target identification unit 94 means an identification to such an extent that the target can be roughly distinguished from the other parts. Therefore, the target identification unit 94 does not have to obtain the necessary target information.

The information combining unit 96 associates the license plate N, included in the first image G1 and the first image G3, with the number information, acquired by the information acquisition unit 80, during the period in which the number information and the regulated speed information can be acquired, while maintaining synchronization between the license plate N and the number information in point of time (with respect to time). Furthermore, during that period, the information combining unit 96 associates the speed sign V, included in the first image G1, and the speed sign V, included in the first image G3, with the regulated speed information, acquired by the information acquisition unit 80, while maintaining synchronization between the speed sign V and the regulated speed information in point of time (with respect to time). During the period in which the number information and the regulated speed information cannot be acquired, the information combining unit 96 associates the already acquired number information with the license plate N in the first image G1 and the first image G3, and the already acquired regulated speed information and with the speed sign V included in the first image G1 and the first image G3.

In the description above, to “associate” means to associate one piece of information with another piece of information. Furthermore, “association” is not limited to the association between one piece of information and another piece of information that have been individually recorded but includes the collective recording (“combining”, “superimposing”) of one piece of information and another piece of information. In the description below, “combined information” means information created by combining target information and a first image in such a way that they are synchronized with respect to time.

The combined information recording unit 98 records the combined information, combined by the information combining unit 96, when the trigger signal (ON) is received. The combined information recording unit 98 stops recording the combined information, combined by the information combining unit 96, when the trigger signal (OFF) is received. In the embodiment, an example of combining target information with the first image G1 or G3 is shown in such a way that the target information is superimposed (overlapped) on the first image G1 or G3. Combining the target information with the first image G1 or G3 includes not only superimposing the target information on the first image G1 or G3 but also displaying the target information side by side with the first image G1 or G3 to form one image.

### Relationship Between Inter-Vehicle Distance and Image

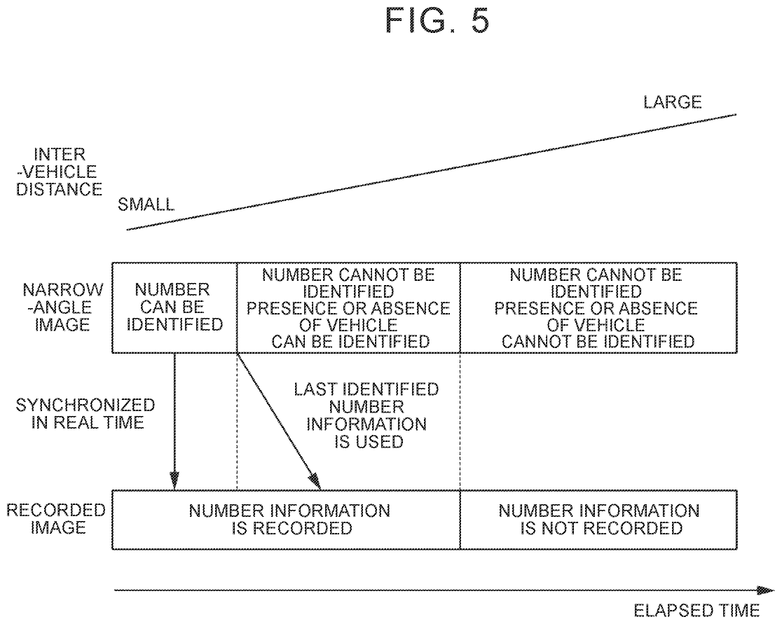

FIG. 5 shows how the number information on the target vehicle C (see FIG. 2) is identified and recorded in this embodiment. More specifically, FIG. 5 shows the relationship between the inter-vehicle distance from the vehicle 10 to the target vehicle C and the narrow-angle image (second image G2, G4) and the recorded image (the image after the association). The regulated speed information is not shown in the figure. In the example shown in the figure, the longer the elapsed time from the recording start point, the longer the inter-vehicle distance.

When the inter-vehicle distance is small, the number information can be identified by the narrow-angle image. Therefore, the recorded image in which the wide-angle image (first image G1 or G3) and the number information are synchronized in real time is recorded in the recording unit 90 (see FIG. 4). When the inter-vehicle distance is slightly longer (increased), the number information cannot be identified, but the presence or absence of the target vehicle C can be identified. Therefore, the wide-angle image and the number information on the target vehicle C at the time when the number information can be identified are associated and recorded in the recording unit 90.

When the inter-vehicle distance is large (very long), neither the number information on the target vehicle C nor the presence or absence of the target vehicle C can be identified. Therefore, the number information is not recorded in the recording unit 90. When the inter-vehicle distance is too small (see FIG. 6), the license plate N is hidden. In this case, the number information cannot be acquired but the presence or absence of the target vehicle C can be identified. For this reason, the wide-angle image when the distance between vehicles is too small and the number information on the target vehicle C identified by the narrow-angle image before the distance between the vehicles is too small are associated and recorded in the recording unit 90.

### Operation and Effect

Next, the operation of the information recording device 30 of the present embodiment will be described.

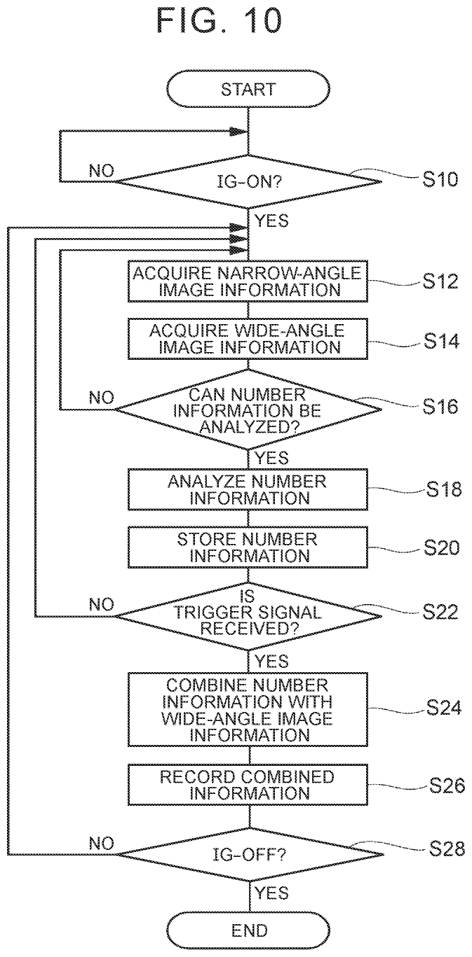

FIG. 10 is a flowchart showing a flow of the information recording processing performed by the ECU 32 (see FIG. 3). For the components of the vehicle 10 and the information recording device 30, see FIG. 1 to FIG. 4. The figure numbers are omitted in the description below. In the example below, the information recording of a target behind the vehicle 10 will be described. The information recording of a target in front of the vehicle 10 will be described later. In the description below, it is assumed that the number information is selected as the target information to be recorded.

In the ECU 32, the CPU 34 reads the information recording processing program from the ROM 35 or the storage 37, loads the program into the RAM 36, and executes the program to perform the information recording processing.

In step S10, the CPU 34 checks the signal, detected by the ignition sensor 59, to determine whether the ignition key is ON. When it is determined that the ignition key is the ON (S10: Yes), the processing proceeds to step S12. When it is determined that the ignition key OFF (S10: No), step S10 is repeated.

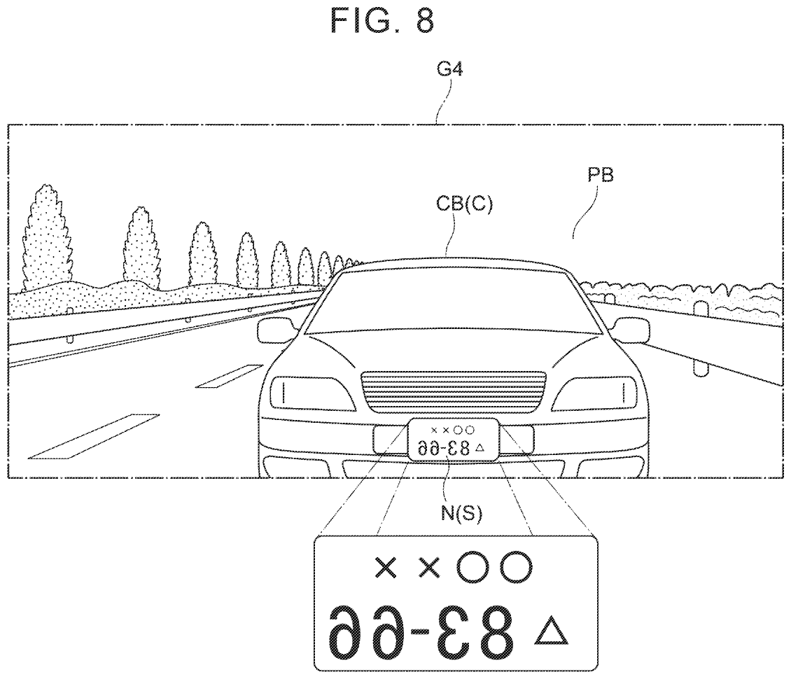

In step S12, the CPU 34 acquires the narrow-angle image information (second image G4 (see FIG. 8)) using the rear narrow-angle capturing unit 74. At this time, the capturing-time information obtained from the timer 58 is associated with the second image G4. Then, the processing proceeds to step S14.

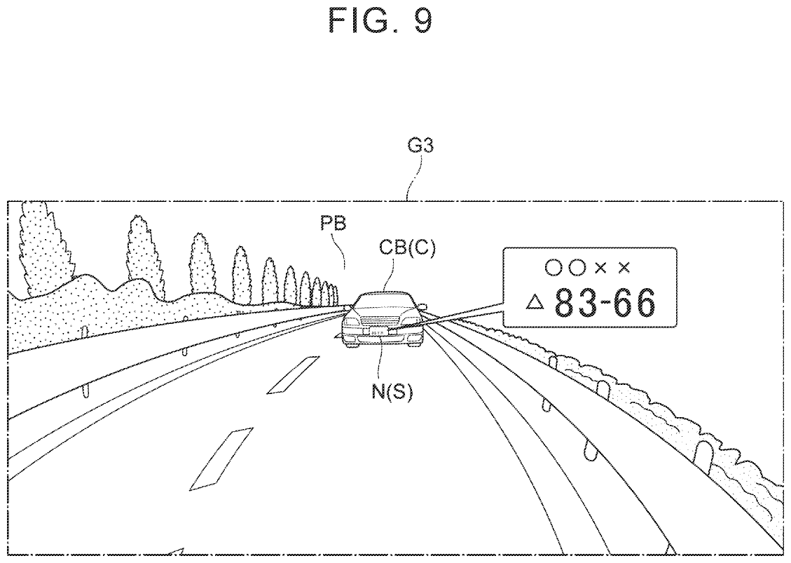

In step S14, the CPU 34 acquires the wide-angle image information (first image G3 (see FIG. 9)) using the rear wide-angle capturing unit 64. At this time, the capturing-time information obtained from the timer 58 is associated with the first image G3. Then, the processing proceeds to step S16.

In step S16, the CPU 34 determines whether the number information on the license plate N of the following vehicle CB can be analyzed. Whether the number information can be analyzed is determined, for example, by determining whether the inter-vehicle distance between the vehicle 10 and the following vehicle CB is within the range of a preset inter-vehicle distance. When it is determined that the number information can be analyzed (S16: Yes), the processing proceeds to step S18. When it is determined that the number information cannot be analyzed (S16: No), the processing proceeds to step S12.

In step S18, the CPU 34 analyzes the number information on the following vehicle CB using the target analysis unit 86 (see FIG. 8). Then, the processing proceeds to step S20.

In step S20, the CPU 34 stores the analyzed number information in the target information recording unit 88. Then, the processing proceeds to step S22.

In step S22, the CPU 34 determines whether the trigger signal is received. In other words, the CPU 34 determines whether the output signals from the recording switch 55 and the collision prediction sensor 56 are detected. When the trigger signal is received (S22: Yes), the processing proceeds to step S24. When the trigger signal is not received (S22: No), the processing proceeds to step S12.

In step S24, the CPU 34 obtains the combined information (the first image G3 shown in FIG. 9) by combining (associating) the number information with the wide-angle image information (the first image G3). Then, the processing proceeds to step S26.

In step S26, the CPU 34 causes the recording unit 90 to record the combined information obtained in step S24. Then, the processing proceeds to step S28.

In step S28, the CPU 34 determines whether the ignition key is OFF. When it is determined that the ignition key is OFF (S28: Yes), the program ends. When it is determined that the ignition key is ON (S28: No), the processing proceeds to step S12.

As described above, the information recording device 30 performs the processing as follows. The first capturing unit 60 captures the first image G3 at the first angle of view θ3 that is relatively wide. The second capturing unit 70 captures the second image G4, which includes the target information, at the second angle of view θ4 that is narrower than the first angle of view θ3. Furthermore, the information acquisition unit 80 acquires the target information from the second image G4. Then, the recording unit 90 records the target information in association with the first image G3. In this case, the specific target part S, even if not identified in the first image G3, can be identified by the target information associated with the first image G3, making it possible to record an image suitable for information recording of the vehicle 10 without adding a new capturing unit.

Since the target information includes the number information, the information recording device 30 can uniquely determine one target vehicle based on the target information, allowing the target vehicle to be identified without recording a plurality pieces of target information.

In addition, since the horizontal angle of view of the first capturing unit 60 is set to 180° or more in the information recording device 30, the capturing range is larger than that of a configuration in which the horizontal angle of view is less than 180°. This means that more surrounding information on the vehicle 10 can be acquired.

Next, the information recording of a target in front of the vehicle 10 will be described. FIG. 11A shows the second image G2 in front of the vehicle 10 obtained using the information recording device 30 (see FIG. 3). In the second image G2, the number information on the license plate N of the preceding vehicle CA and the regulated speed information on the speed sign V can be identified. The number information and the regulated speed information are obtained from the second image G2.

FIG. 11B shows the first image G1 in front of the vehicle 10 as another example of the combined information (recorded image) obtained using the information recording device 30 (see FIG. 3). In the combined information, the license plate N of the preceding vehicle CA and the number information are associated, and the speed sign V and the regulated speed information are associated. In this way, the target information and the wide-angle image may be associated in front of the vehicle 10 to create the combined information and the created combined information may be recorded by the combined information recording unit 98 (see FIG. 4).

In the example shown in FIG. 11B, the target information includes the vehicle traveling rule information (for example, regulated speed information) on the surrounding area PA of the preceding vehicle CA. Therefore, it is possible to determine whether the preceding vehicle CA is traveling in compliance with the vehicle traveling rule. For example, assume that the vehicle 10 (host vehicle) is a police car and that the vehicle is following the preceding vehicle CA at a speed of 60 km/h on a road where the regulated speed (speed limit) is 40 km/h. In such a case, the images shown in FIG. 11A and FIG. 11B (combined information), if obtained, indicate that the preceding vehicle CA is in violation. In addition, an image (combined information) in which the preceding vehicle CA has entered an intersection where the traffic light SG is red, if obtained, indicates that the preceding vehicle CA is in violation. Furthermore, the number information uniquely identifies the preceding CA.

Note that the present disclosure is not limited to the embodiment described above.

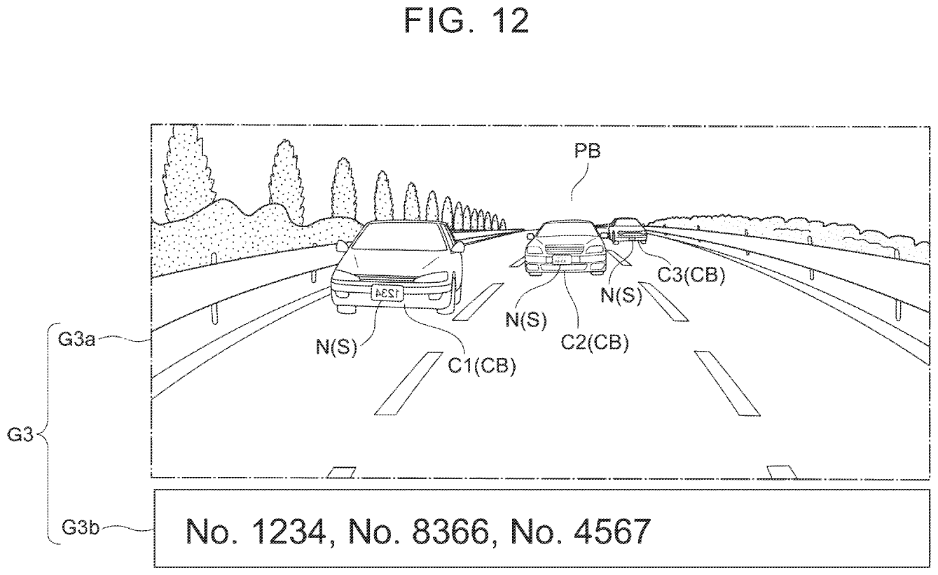

FIG. 12 shows another example of the combined information obtained by the information recording device 30 (see FIG. 3). In this example, the first image G3 is shown in which the following vehicles CB (C1, C2, C3) are traveling behind the vehicle 10 (see FIG. 1). The first image G3 is composed of two images: one is an image displayed in the image display area G3a and the other is an image (text information) displayed in the information display area G3b that is displayed in parallel with the image display area G3a. In the information display area G3b, the number information on the following vehicles C1, C2, and C3 are indicated as “1234”, “8366”, and “4567”. In this manner, a plurality of pieces of target information corresponding to a plurality of target vehicles C may be collectively shown.

Although the three pieces of number information are combined preferably with following vehicles C1, C2, and C3 in a one-to-one correspondence, rough information association (combination) may also be used in which one of the three pieces of number information corresponds to one of the following vehicles C1, C2, and C3. The number of target vehicles C is not limited to one or three, but may be two or four or more.

In the information recording device 30, the side cameras 44 shown in FIG. 1 may be used as the rear narrow-angle camera 46. The first angle of view θ1 may be smaller than 180°. The target information recorded in the recording unit 90 is not limited to the number information and the vehicle traveling rule information; instead, the target information may be, for example, the face of the driver of the following vehicle CB or the face of a passenger in the passenger seat. In addition, the lighting color information on the traffic light SG may be acquired as the vehicle traveling rule information for combination with the first image G1 or G3.

In the flowchart shown in FIG. 10, step S12 and step S14 may be performed simultaneously.

In the embodiment described above, the CPU 34 reads the software (program) for performing the information recording processing. This information recording processing may be performed by various processors other than the CPU 34. Examples of the processors that can be used in this case include the following two processors: (1) a programmable logic device (PLD), such a field-programmable gate array (FPGA), that is a processor having a circuit configuration that can be changed after manufacture and (2) a dedicated electric circuit, such as an application specific integrated circuit (ASIC), that is a processor having a circuit configuration specifically designed for performing specific processing. The processing described above may be performed by one of these various processors or by a combination of two or more processors of the same type or different types (for example, a plurality of FPGAs and a combination of a CPU and an FPGA). More specifically, the hardware structure of these various processors is an electric circuit that combines circuit elements such as semiconductor devices.

Although previously stored (installed) in the ROM 35 or the storage 37 in the embodiment described above, the information recording processing program may be stored in other recording media. For example, the program may be stored on a recording medium such as a compact disk read only memory (CD-ROM), a digital versatile disk read only Memory (DVD-ROM), and a universal serial bus (USB) memory for distribution to the user. Furthermore, the information recording processing program may be downloaded from an external device via a network.

What is claimed is:

1. An in-vehicle information recording device comprising:
a first capturing unit configured to capture a first image at a first angle of view, the first image including at least a part of a target vehicle in front of or behind a vehicle and a surrounding area of the target vehicle;
a second capturing unit configured to capture a second image at a second angle of view that is narrower than the first angle of view, the second image including target information so that the target information on a specific target part of the target vehicle or the surrounding area is identifiable;
an information acquisition unit configured to acquire the target information from the second image; and
a recording unit configured to record the target information in association with the first image, the target information being acquired by the information acquisition unit.

2. The in-vehicle information recording device according to claim 1, wherein the recording unit is configured to record the target information in association with the first image, the target information including number information on the target vehicle.

3. The in-vehicle information recording device according to claim 1, wherein the recording unit is configured to record the target information in association with the first image, the target information including vehicle traveling rule information on the surrounding area.

4. The in-vehicle information recording device according to claim 1, wherein a horizontal angle of view that is the first angle of view of the first capturing unit is set to 180° or more.
